(19) United States
(12) Patent Application Publication
(10) Pub. No.: US 2007/0155206 A1
(43) Pub. Date: Jul. 5, 2007

(54) Electrical connector assembly with cover

(75) Inventor: Chia-Wei Fan, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/650,172

(22) Filed: Jan. 5, 2007

(30) Foreign Application Priority Data
Jan. 5, 2006 (CN) 200620068278.3

(51) Int. Cl. H01R 13/44

(52) U.S. Cl. 439/135

(57) ABSTRACT

An electrical connector assembly (1) includes a connector unit including at least two elongated electrical connectors (2) and having a region defined by a periphery, a circuit board (3) for the connector unit to be mounted thereon, and a cover (4) for covering the region of the connector unit. The cover includes generally rigid posts (43) for positioning outside the periphery of the connector unit, and a generally flexible arm (44) defined on each of the posts for engaging onto the circuit board. Since the at least two electrical connectors are covered by a common cover, damage to electrical terminals and peripheral portions of the electrical connector, resulting from the frequent remove of multi-covers, are prevented.

### BACKGROUND OF THE INVENTION

1. Field of the Invention

The present invention relates to the art of electrical connectors, and more particularly to an electrical connector assembly including a cover for covering at least two electrical connectors.

2. Description of the Related Art

One conventional electrical connector assembly 30 is shown in FIG. 6. The electrical connector assembly 30 includes an electrical connector 10 defining an elongated body, a cover 20 having a shape dimensioned to cover the elongated body of the electrical connector 10 and adapted for engaging the cover 20 onto the electrical connector 10. More specifically, the cover 20 includes a pair of locating walls 21 at opposite lateral sides of the cover 20, each wall 21 having a recess 212 defined at a middle portion thereof. The body of the electrical connector 20 forms a pair of longitudinal tabs 13 projecting from opposite sides of the electrical connector body and adapted to extend into the recesses 212 of the cover 20 so as to engage the cover 20 onto the electrical connector 10. For most instances, several electrical connectors, to be mounted on a predetermined region of a circuit board, are required to be covered. If each connector is equipped with a single cover, frequently removing the covers from the associated connectors will result in damages of electrical terminals within the electrical connectors, and damages of peripheral portions of the bodies of the electrical connectors. Therefore, there is a need to provide a new electrical connector assembly for providing a cover member for commonly covering electrical connectors.

### SUMMARY OF THE INVENTION

An electrical connector assembly according to an embodiment of the present invention includes a connector unit including at least two elongated electrical connectors and having a region defined by a periphery, a circuit board for the connector unit to be mounted thereon, and a cover for covering the region of the connector unit. The cover includes generally rigid posts for positioning outside the periphery of the connector unit, and a generally flexible arm defined on each of the posts for engaging onto the circuit board. As compared with the prior art, since the at least two electrical connectors are covered by a common cover, damage to electrical terminals and peripheral portions of the electrical connector, resulting from the frequent remove of multi-covers, are prevented.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of an electrical connector assembly according to an embodiment of the present invention;

FIG. 2 is another view of the cover of FIG. 1;

FIG. 3 is an assembled, perspective view of the electrical connector assembly of FIG. 1;

FIG. 4 is a side view of the electrical connector assembly; and

FIG. 5 is a perspective view of a cover according to a second embodiment of the present invention; and

FIG. 6 is an exploded, perspective view of a conventional electrical connector assembly.

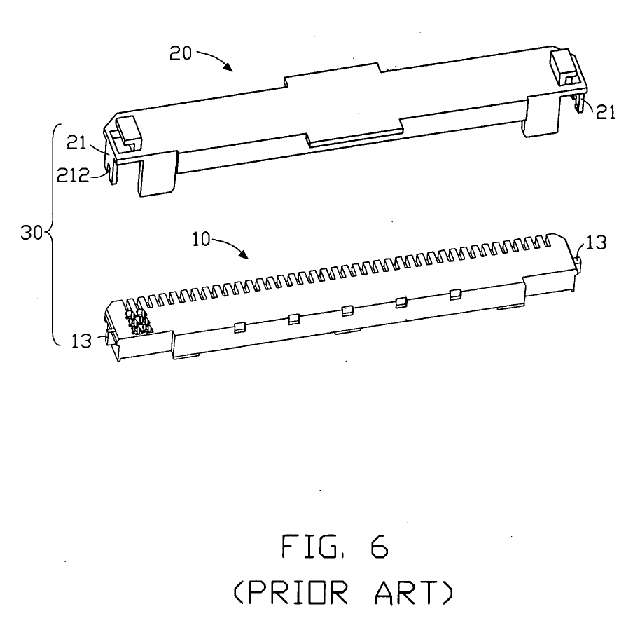

### DETAILED DESCRIPTION OF PREFERRED EMBODIMENT

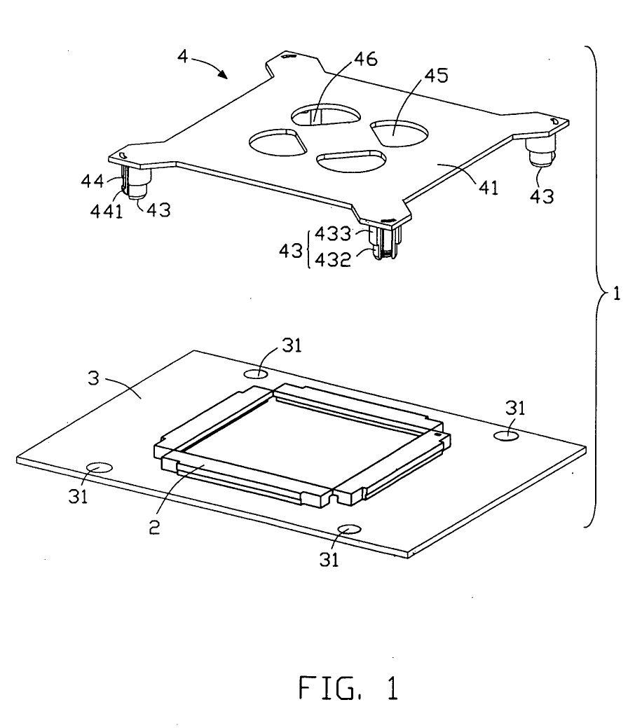

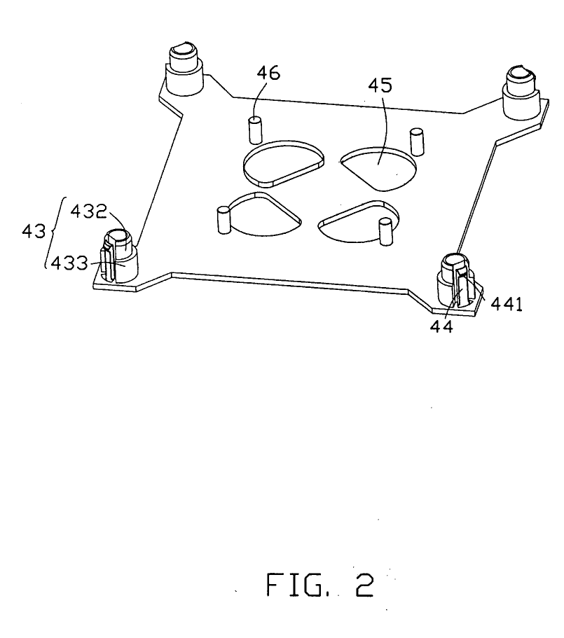

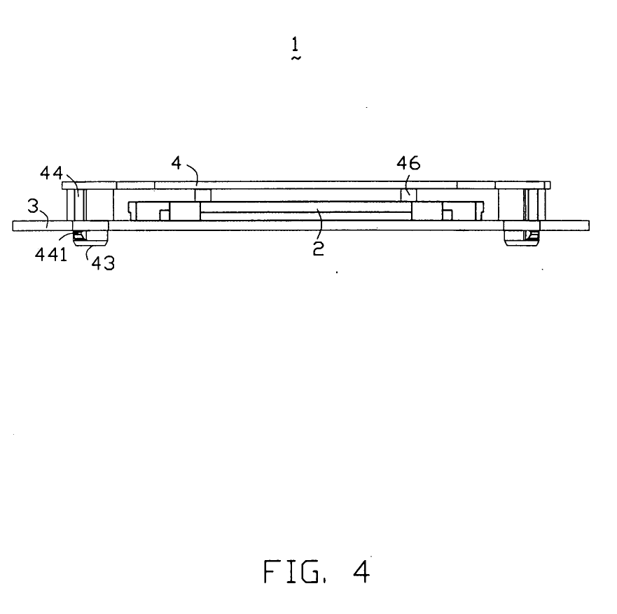

Referring to FIGS. 1 to 4, an electrical connector assembly 1 according to the first embodiment of the present invention comprises a connector unit, a circuit board 3 for the connector unit to be mounted thereon, and a cover 4 for covering the connector unit. The connector unit includes at least two electrical connectors 2, and has a region defined by a periphery. In this embodiment, the connector unit includes four identical electrical connectors 2 each having an elongated shape. The four electrical connectors 2 are combined to form a generally square area. The circuit board 3 includes openings 31 positioned adjacent to the periphery defined by the connector unit, and adapted for flexible arms 44 to extend thereinto.

The cover 4 has a shape in compliance with the region defined by the periphery of the connector unit. The cover 4 includes generally rigid posts 43 at four corners of the cover 4 and configured for positioning outside the periphery of the connector unit. Each of the posts 43 is stepped in shape to form an upper post part 433 and a lower post part 432, the upper post part 433 in diameter being larger than that of the lower post part 432 or that of the opening 31 defined on the circuit board. The upper post part 433 is configured for positioning beyond the opening 31 of the circuit board 3 so as to be rested on a top portion that defines the opening 31, while the lower post part 432 is adapted for engaging into the opening 31. A generally flexible arm 44 is defined on the post 43 for extending into the opening 31, with a catching portion 441 at a free end of the flexible arm 44 for grasping a bottom portion that defines the opening 31. The cover 4 has a top planar surface 41 with a plurality of through holes 45 at a center thereof for facilitating grasp of the cover 4 by extending one's fingers into these through holes 45. In this embodiment, the cover includes four identical holes 45 arranged symmetrical with respect to a center point of the cover 4 so as to define a grasping area substantially proportional to the region defined by the connector unit. At least a pair of spaced rods 46 extends from a bottom surface of the cover 4, serving as a supporting and locating member of the cover 4. In this embodiment, the cover 4 includes four rods 46 located around respective corners of the grasping area.

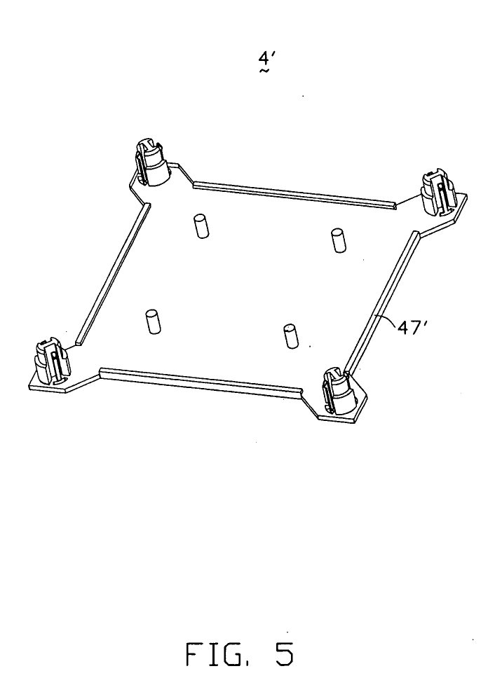

Referring to FIG. 5, a cover 4′ according to the second embodiment of the present invention is shown. In this embodiment, there is no holes defined on a center of the cover 4′. The cover 4′ further includes side walls 47′ extending from an outer edge of the cover 4′ for protecting the cover from lateral touch by one's fingers.

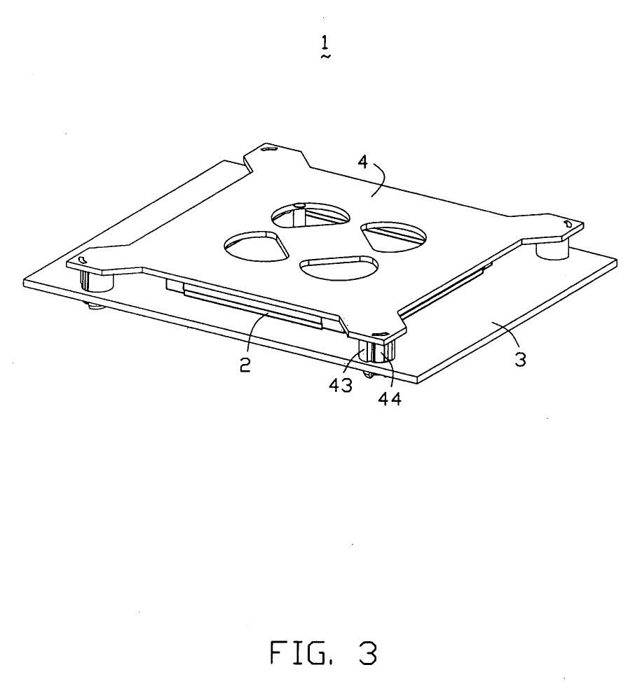

Referring to FIGS. 1 and 3, in assembly, the four electrical connectors 2 are pre-mounted onto the circuit board 3. The cover 4 then engages onto the circuit board 3 by the upper post part 433 positioning beyond the opening 31 of the circuit board 3 to be rested on the top portion that defines the opening 31, and the lower post part 432 adapted for engaging into the opening 31, and the catching portion 441 of the flexible arm 44 adapted for grasping the bottom portion of the opening 31, so as to cover the pre-mounted electrical connectors 2. As compared with the prior art, since the four electrical connectors 2 are covered by a common cover 4, damage to electrical terminals and peripheral portions of the electrical connectors 2, resulting from the frequent remove of multi-covers, are prevented.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector assembly comprising:
a connector unit including at least two elongated electrical connectors, the connector unit having a region defined by a periphery;
a circuit board for the connector unit to be mounted thereon; and
a cover for covering said region of the connector unit, the cover having generally rigid posts for positioning outside the periphery of the connector unit, and a generally flexible arm defined on each of the posts for engaging onto the circuit board.

2. The electrical connector assembly as recited in claim 1, wherein the circuit board has openings for said flexible arms to extend into.

3. The electrical connector assembly as recited in claim 2, wherein each post is stepped in shape to form an upper post part and a lower post part, the upper post part configured for positioning beyond the opening of the circuit board, the lower post part configured for engaging into the opening.

4. The electrical connector assembly as recited in claim 1, wherein the cover includes at least a pair of spaced rods.

5. The electrical connector assembly as recited in claim 1, wherein the cover includes side walls extending from an outer edge of the cover.

6. The electrical connector assembly as recited in claim 1, wherein the cover defines a top planar surface with a plurality of through holes at a center thereof.

7. An electrical connector assembly comprising:
a printed circuit board defining a plurality of through holes in a first periphery of the printed circuit board;
a connector unit including a plurality of connector sections commonly defining a region with thereof a second periphery essentially located within the first periphery;
a cover dimensioned larger than the second periphery and covering said region of the connector unit, the cover having a plurality of outer downwardly extending retention posts locked to the corresponding through holes, respectively, and a plurality of inner downwardly extending supporting posts located within the second periphery and abutting against a top surface of the printed circuit board.

8. The electrical connector assembly as claimed in claim 7, wherein said inner supporting posts essentially intimately face an interior side of said connector unit.

9. The electrical connector assembly as claimed in claim 7, wherein the cover defines at least an opening downwardly communicating with the region.

10. The electrical connector assembly as claimed in claim 8, wherein the region defines an opening in which the inner supporting posts are located.

11. The electrical connector assembly as claimed in claim 7, wherein each of the outer posts defines an upper large diameter section and a lower small diameter section, and wherein the upper large diameter section abuts against the top surface of the printed circuit board and the lower small diameter section extends through the corresponding through hole.

12. An electrical connector assembly comprising:
a printed circuit board defining a plurality of through holes in a first periphery of the printed circuit board;
a connector unit including a plurality of connector sections commonly defining a region with thereof a second periphery essentially located within the first periphery;
a cover dimensioned larger than the second periphery and covering said region of the connector unit, the cover having a plurality of outer downwardly extending retention posts each defining a large arced stiff portion seated upon a top surface of the printed circuit board and a small arced flexible portion with a hook locked to the corresponding through hole.
